(19) United States
(12) Patent Application Publication
(10) Pub. No.: US 2023/0315430 A1
(43) Pub. Date: Oct. 5, 2023

(54) CONTROL DEVICE AND CONTROL METHOD

(71) Applicant: HONDA MOTOR CO., LTD., Tokyo (JP)

(72) Inventor: Yusuke Yoshimura, Tokyo (JP)

(21) Appl. No.: 18/170,701

(22) Filed: Feb. 17, 2023

(30) Foreign Application Priority Data
Mar. 30, 2022 (JP) 2022-056980

(51) Int. Cl. G06F 8/65; G06F 8/61

(52) U.S. Cl. CPC G06F 8/65; G06F 8/61

(57) ABSTRACT

A control device including: a program management unit that manages a process of installing a program for operating electronic equipment, onto a program execution unit for executing the program, and the execution of the program by the program execution unit; and a detection unit that detects a use state of the electronic equipment, wherein the program management unit executes, based on the use state of the electronic equipment detected by the detection unit, a restriction operation at least either when the program is installed or when the program is executed, and the restriction operation includes any one of outputting a notification, restricting the installation of the program, and restricting the execution of the program.

### INCORPORATION BY REFERENCE

The present application claims priority under 35 U.S.C.§ 119 to Japanese Patent Application No. 2022-056980 filed on Mar. 30, 2022. The content of the application is incorporated herein by reference in its entirety.

### BACKGROUND OF THE INVENTION

### Field of the Invention

The present invention relates to a control device and a control method.

### Description of the Related Art

In recent years, for the purposes of improving traffic safety and the ride comfortability of vehicles, functions of software that is installed on vehicles have been evolving. Although software of this type is installed on on-vehicle equipment during the manufacturing of a vehicle, it is also anticipated that new software will be installed on a vehicle being used. For example, Japanese Patent Application Laid-Open No. 2012-113394 discloses a technique to avoid disrupting the operation of an existing program when downloading a new program from a server onto on-vehicle equipment.

### SUMMARY OF THE INVENTION

By the way, when installing new software for controlling electronic equipment, it is impossible to predict, in advance, the manner in which the software to be installed causes the electronic equipment to operate. Therefore, there is a possibility that a load that was not anticipated when the electronic device was manufactured will be applied to the electronic device as a result of installing the new software. In such a case, the electronic equipment may have a shorter life than anticipated, or an unanticipated problem may occur. For example, there is a possibility that improvements in the traffic safety and the ride comfortability of the vehicle will be hindered by unintended troubles or problems of electronic equipment installed on the vehicle.

The present invention has been made in view of such a background, and objects of the present invention are to prevent or reduce troubles or problems of electronic equipment due to installation of new software for controlling the electronic equipment, and realize an appropriate use of the electronic equipment, and consequently contribute to development of a sustainable transportation system.

One aspect to achieve the objects is a control device including: a program management unit that manages a process of installing a program for operating electronic equipment, onto a program execution unit for executing the program, and the execution of the program by the program execution unit; and a detection unit that detects a use state of the electronic equipment, wherein the program management unit executes, based on the use state of the electronic equipment detected by the detection unit, a restriction operation at least either when the program is installed or when the program is executed, and the restriction operation includes any one of outputting a notification, restricting the installation of the program, and restricting the execution of the program.

According to the above configuration, when installing or executing the program for operating electronic equipment, a restriction can be imposed depending on the use state of the electronic equipment by a new program. Thus, it is possible to restrict the installation or execution of a program that puts an inappropriate load on the electronic equipment, thereby preventing or reducing unexpected troubles of the electronic equipment, and achieving a long life of the electronic equipment. For example, it is possible to realize an appropriate use of electronic equipment mounted on a vehicle, and improve the safety and ride comfortability of the vehicle.

### BRIEF DESCRIPTION OF THE DRAWINGS

FIG. 1 is a schematic configuration diagram of a control system for a vehicle;

FIG. 2 is a view showing a schematic configuration of a management system;

FIG. 3 is a block diagram showing a main configuration of the control system;

FIG. 4 is a flowchart showing an operation of a central ECU;

FIG. 5 is a flowchart showing the operation of the central ECU; and

FIG. 6 is a flowchart showing the operation of the central ECU.

### DETAILED DESCRIPTION OF THE PREFERRED EMBODIMENT

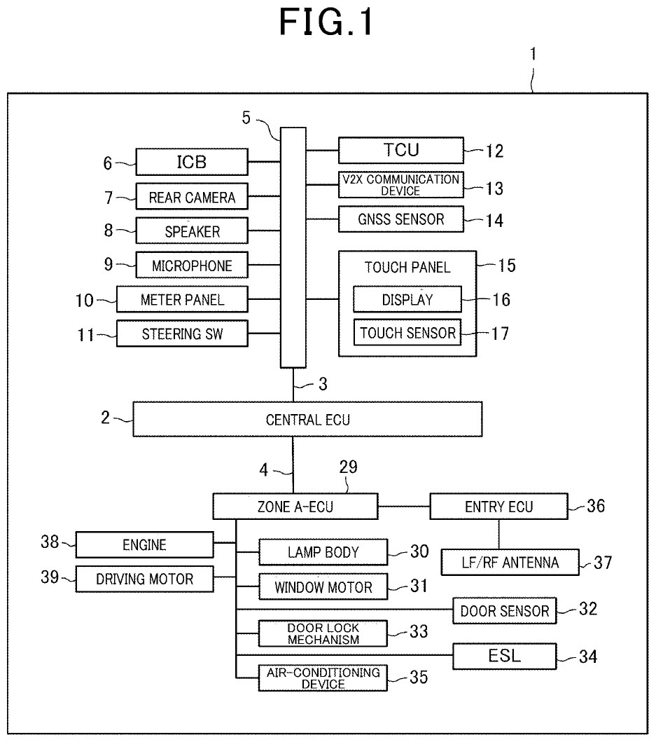

FIG. 1 is a view showing a control system 1 for a vehicle.

The control system 1 includes a central ECU 2 that performs overall control of the vehicle, and information processing. The central ECU 2 is connected to communication lines including a first communication line 3 and a second communication line 4. The central ECU 2 realizes a gateway function for managing delivery of communication data between these communication lines. Moreover, the central ECU 2 executes over the air (OTA) management. The OTA management includes control related to a process for downloading from an external server an update program for on-vehicle device provided on the vehicle, and a process for applying the downloaded update program to the on-vehicle device.

The first communication line 3 and the second communication line 4 are constituted by buses for performing communications conforming to a standard such as CAN and Ethernet (registered trademark), or communication lines for performing peer-to-peer (P2P) communications. Note that the first communication line 3 may be constituted by a single communication line, or a plurality of communication lines for performing communications conforming to the same standard, or a plurality of communication lines for performing communications conforming to different standards. The same can be said for the second communication line 4.

Connected to the first communication line 3 through an in-vehicle connection link 5 are an information control box (ICB) 6, a rear camera 7, a speaker 8, a microphone 9, a meter panel 10, and a steering switch 11. The rear camera 7 is a camera for photographing an area backward of the vehicle. The meter panel 10 displays information about an operating state of the vehicle, including a vehicle speed.

Moreover, connected to the in-vehicle connection link 5 are a telematics control unit (TCU) 12, a vehicle-to-everything (V2X) communication device 13, a GNSS sensor (GNSS: global navigation satellite system) 14, and a touch panel 15. The TCU 12 is a wireless communication device conforming to a communication standard of a mobile communication system. The V2X communication device 13 has a transmitter and a receiver and performs vehicle-to-vehicle communications, and/or road-to-vehicle communications. The touch panel 15 includes a display 16 and a touch sensor 17.

The ICB 6 is an IVI (in-vehicle infotainment)-ECU. The ICB 6 provides an occupant of the vehicle with various types of information and entertainment, using the speaker 8, the microphone 9, the GNSS sensor 14, the touch panel 15, etc.

The in-vehicle connection link 5 is constituted by a plurality of communication transmission paths conforming to various communication standards. The in-vehicle connection link 5 may include, for example, a plurality of network transmission paths. In this case, the plurality of network transmission paths may be connected to each other through a device having a gateway function. Further, the in-vehicle connection link 5 may include a transmission path for performing P2P communications. For the network transmission path, it is possible to employ various types of communication buses for performing network communications according to various standards. Examples of the types of standards are CAN, Ethernet, universal serial bus (USB), local interconnect network (LIN), and low voltage differential signaling (LVDS), and there may be other standards.

A zone A-ECU 29 is connected to the second communication line 4. The zone A-ECU 29 is connected to a lamp body 30 and a window motor 31. The lamp body 30 includes, for example, a head lamp, a tail lamp, and a directional signal lamp. The window motor 31 opens and closes a vehicle window. Furthermore, the zone A-ECU 29 is connected to a door sensor 32, a door lock mechanism 33, an electronic steering lock (ESL) 34, and an air-conditioning device 35. The door sensor 32 detects an operation on a vehicle door. The door lock mechanism 33 locks and unlocks the door of the vehicle. An entry ECU 36 is connected to the zone A-ECU 29. The entry ECU 36 is connected to an LF/RF antenna 37 for wirelessly communicating with an electronic key of the own vehicle. The electronic key is an electronic device having a wireless communication function, and is called a smart key or FOB key. The entry ECU 36 processes a user's access to the control system 1 from outside of the vehicle, in cooperation with another on-vehicle ECU, and realizes a so-called smart entry operation.

In addition, an engine 38 and a driving motor 39 are connected to the zone A-ECU 29. The engine 38 and the driving motor 39 are driving sources for driving a vehicle V on which the control system 1 is installed. The vehicle V includes one or both of the engine 38 and the driving motor 39. The driving motor 39 may include a plurality of motors.

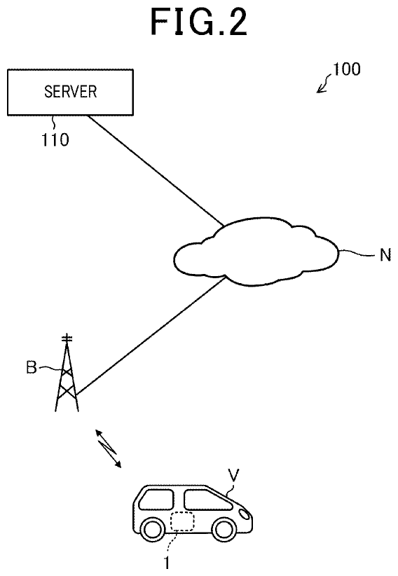

FIG. 2 is a view showing a schematic configuration of a management system 100.

The management system 100 is a system that allows updating of a program, which is executed by various ECUs constituting the control system 1. The management system 100 includes a server 110.

The server 110 is comprised by a computer having a CPU and connected to the control system 1 through a communication network N.

The communication network N includes, for example, a cellular communication network, a Wi-Fi (registered trademark) network, Bluetooth (registered trademark), the Internet, a wide area network (WAN), a local area network (LAN), a public line, a provider device, a leased line, and a base station, and, in FIG. 2, a base station B is illustrated. The TCU 12 provided in the control system 1 executes cellular communications with the base station B, and thereby executes data communications with an external device through the communication network N.

The control system 1 executes communications with the server 110 through the TCU 12, and thereby allows downloading, from the server 110, update data for updating the program which is executed by the various ECUs of the control system 1. In the control system 1, means for downloading the update data from the server 110 and updating the program is equivalent to the OPA. The server 110 is an external device for the control system 1. The TCU 12 can be called a communication unit.

The control system 1 can download an application program to be executed by the ECUs of the control system 1 from the server 110, and install the application program onto the ECUs. In this case, the control system 1 may download the application program from a server device different from the server 110 that provides a control program for the ECUs.

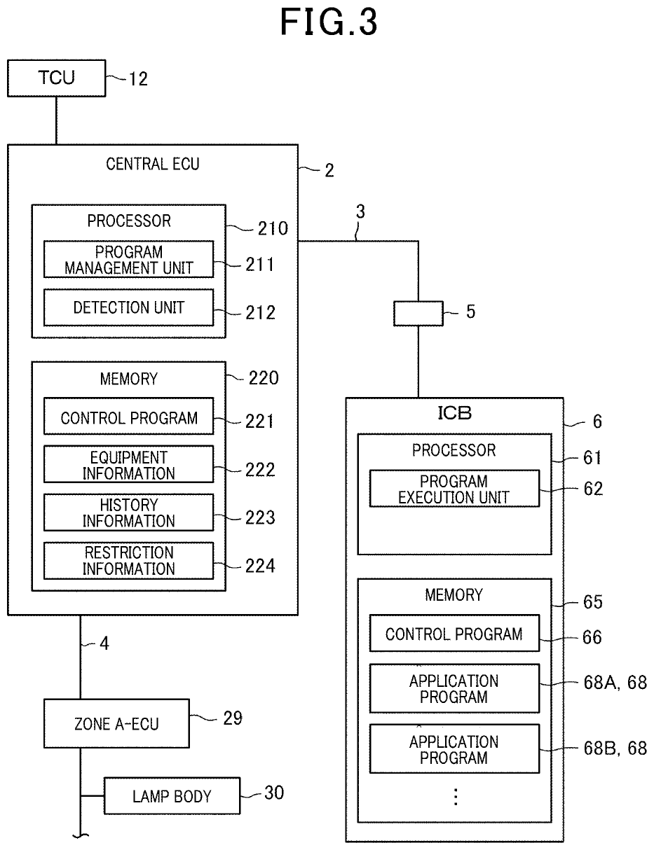

FIG. 3 is a block diagram showing a main configuration of the control system 1 of a first embodiment. FIG. 3 shows part of the configuration relating to updating of the program in the control system 1, but does not hinder the control system 1 from including a configuration which is not shown in FIG. 3.

In the control system 1, the central ECU 2 includes a processor 210 and a memory 220. The processor 210 is constituted by, for example, a central processing unit (CPU), a micro controller unit (MCU), or a micro processing unit (MPU). The memory 220 stores, in a non-volatile manner, a program to be executed by the processor 210, and data to be processed by the processor 210. The memory 220 is constituted by, for example, a read-only memory (ROM). The memory 220 may include a random access memory (RAM) that forms a work area for temporarily storing the program and data. In the present disclosure, the central ECU 2 corresponds to one example of a control device.

The central ECU 2 may be constituted by an integrated circuit including the processor 210 and the memory 220 as one unit. Alternatively, the central ECU 2 may include the processor 210, the memory 220, and another circuit as independent pieces of hardware, respectively.

The memory 220 stores a control program 221, equipment information 222, history information 223, and restriction information 224.

The processor 210 executes the control program 221, and thereby controls each part of the central ECU 2, and the devices constituting the control system 1. The processor 210 includes a program management unit 211 and a detection unit 212 as functional units related to the application program which is executed by the ECUs included in the control system 1.

The program management unit 211 manages the installation and execution of a program on the control system 1. The program managed by the program management unit 211 is one form of software, and, in the present embodiment, a subject managed by the program management unit 211 is an application program.

Each of the ECU provided in the control system 1 includes a program for controlling equipment mounted on the vehicle V, and controls the equipment by executing the program. The program of this type is called firmware, middleware, or a control program.

The application program managed by the program management unit 211 may include the above-described basic control program. In the present embodiment, the program management unit 211 manages the application program that is executed in addition to the basic functions of the ECUs. This application program is distinguished from the control program. In other words, the program to be executed by each ECU is provided by a company which manufactures or sells the vehicle V, and is downloaded onto the vehicle V through the communication network N from the server 110 managed by the company.

Alternatively, the program to be executed by each ECU is downloaded onto the vehicle V from a diagnosis device, not shown, by connecting the diagnosis device, which is installed in a dealer and a maintenance shop of the vehicle V, to the control system 1. On the other hand, the application program may be developed or provided by a third party irrelevant to the manufacturer or seller of the vehicle V. The application program of this type is downloaded onto the vehicle V through the communication network N from a server computer different from the server 110.

In the case when an application program is downloaded and installed on the ECU to be managed, the program management unit 211 makes a determination about the application program. Specifically, the program management unit 211 determines whether executing the application program by the ECU puts a high load on the electronic equipment mounted on the vehicle V. For an application program determined to be the program that puts a high load on the electronic equipment, the program management unit 211 executes a restriction operation.

The restriction operation includes at least one of restricting or prohibiting of installation of the application program, restricting or prohibiting of execution of the application program, and giving the user a notification that the application program puts a high load. Here, the restriction includes allowing conditional execution. The notification is, for example, a display through the touch panel 15, an output of sound through the speaker 8, etc.

The detection unit 212 detects various electronic equipment included in the control system 1, and the use state of the electronic equipment mounted on the vehicle V and controlled by the control system 1. Here, the electronic equipment is, for example, the lamp body 30, the window motor 31, the door sensor 32, the door lock mechanism 33, and the ESL 34 shown in FIG. 1. Moreover, the electronic equipment includes the rear camera 7, the speaker 8, the microphone 9, the meter panel 10, the steering switch 11, the touch panel 15, and the air-conditioning device 35. Further, the electronic equipment controlled by the control system 1 may include equipment which is not shown in FIG. 1. Examples of the electronic equipment controlled by the zone A-ECU 29 include a wiper motor for operating a wiper of the vehicle V, and a window washer motor for driving a window washer pump. Furthermore, the electronic equipment may include a seat heater, and a horn mounted on the vehicle V. Additionally, the electronic equipment may include a driving battery for driving the driving motor 39. The electronic equipment controlled by the ECU or the control device capable of communicating through the first communication line 3 or the second communication line 4 can be the subject to be detected by the detection unit 212. There are no restrictions for the number of pieces and type of electronic equipment to be detected by the detection unit 212.

The detection unit 212 always performs, for example, a process for detecting the use state of each piece of electronic equipment provided in the control system 1, and updating the history information 223, during the operation of the control system 1.

In FIG. 3 and the following explanation, an example in which the detection unit 212 detects the use state of the lamp body 30 as one example of the electronic equipment is described.

The equipment information 222 stored in the memory 220 includes information about electronic equipment to be detected by the detection unit 212. For example, the equipment information 222 includes the type of the electronic equipment, information identifying an ECU that controls the electronic equipment, the time of manufacture of the electronic equipment, the useful life or guaranteed operating period of the electronic equipment, the serial number unique to the electronic equipment, etc.

The history information 223 includes information about the history of operations of the electronic equipment. For example, the history information 223 includes the elapsed time from the start of using the electronic equipment, the number of times the electronic equipment has operated, and the operating time of the electronic equipment. Moreover, in a case in which the electronic equipment includes a semiconductor memory element such as flush ROM, the history information 223 may include the number of times of rewriting of the semiconductor memory element. These pieces of information may be cumulative values starting from the time of shipment of the vehicle V from a factory.

The memory 220 is capable of storing the equipment information 222 and the history information 223 individually for each piece of electronic equipment. There are no restrictions for the number of pieces of the equipment information 222 and the history information 223 to be stored in the memory 220. Moreover, types of information included in the equipment information 222 do not need to be unified. The same can be said for the history information 223. For example, the memory 220 may store the equipment information 222 and the history information 223 including different types of information, individually for each piece of electronic equipment.

The restriction information 224 includes information indicating an application program which is subject to a restriction operation performed by the program management unit 211. In other words, the restriction information 224 includes information indicating an application program determined by the program management unit 211 to be the program that puts a high load on the electronic equipment. For each application program, the restriction information 224 may include information indicating the content of the restriction operation executed on the application program by the control program 221.

The subject of the management by the program management unit 211 is the ECUs provided in the control system 1, and there are no restrictions on the type and number of the ECUs. In FIG. 3 and the following explanation, the ICB 6 is described as one example of the ECU which is the subject to be managed by the program management unit 211.

The ICB 6 includes a processor 61 and a memory 65. The processor 61 is constituted by, for example, a CPU, an MCU, or an MPU. The memory 65 stores, in a non-volatile manner, a program to be executed by the processor 61, and data to be processed by the processor 61. The memory 65 is constituted by, for example, a ROM. The memory 65 may include a RAM that forms a work area for temporarily storing the program and data.

The ICB 6 may be constituted by an integrated circuit including the processor 61 and the memory 65 as one unit. Alternatively, the ICB 6 may include the processor 61, the memory 65, and another circuit as independent pieces of hardware, respectively.

The memory 65 stores a control program 66 and an application program 68. The control program 66 is a basic control program to be executed by the processor 61. The processor 61 executes the control program 66, and thereby controls each part of the ICB 6, and equipment subject to control by the ICB 6. The subject of control by the ICB 6 is, for example, the speaker 8, the microphone 9, the GNSS sensor 14, the touch panel 15, etc.

A program execution unit 62 is a functional unit formed by executing the control program 66 with the processor 61, and is, for example, a software platform for executing the application program 68. Alternatively, the program execution unit 62 may be formed by hardware, or may be one function of the processor 61.

The program execution unit 62 executes the application program 68, and thereby operates the electronic equipment subject to control by the ICB 6. For example, the program execution unit 62 executes functions, such as playing a video content, playing music, hands free calling, displaying a map, and searching for information, by executing the application program 68.

The memory 65 stores the application program 68 corresponding to a function to be executed by the program execution unit 62. There are no restrictions on the number of application programs 68 to be stored in the memory 65. Moreover, a single application program 68 may be configured to execute a plurality of functions of the ICB 6.

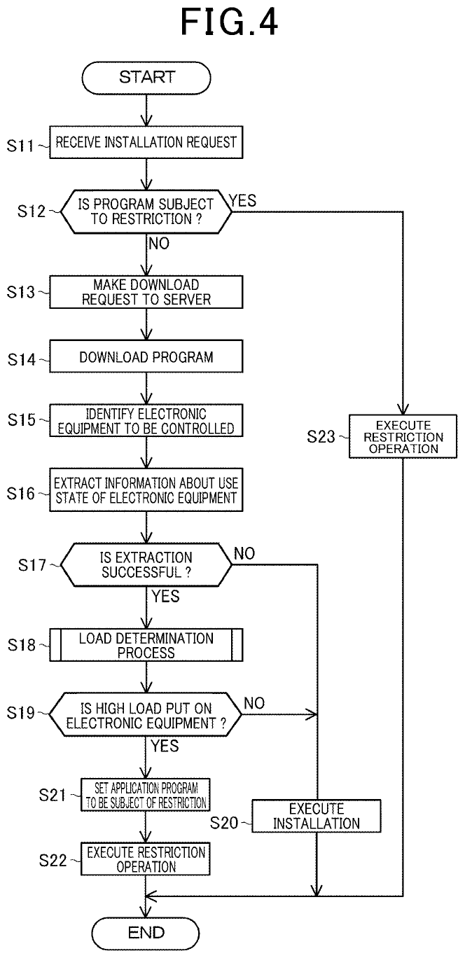

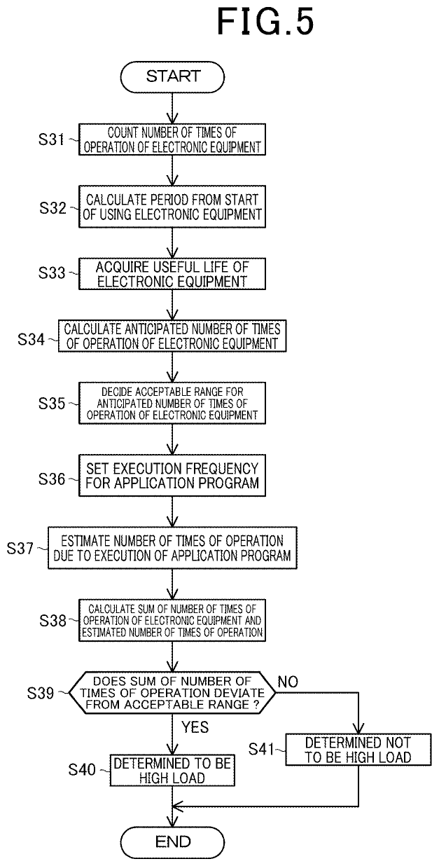

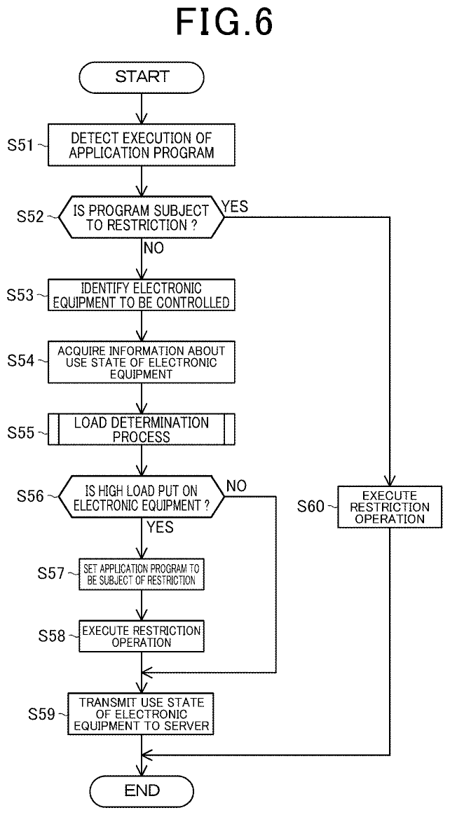

FIG. 4, FIG. 5, and FIG. 6 are flowcharts showing the operations of the central ECU 2. FIG. 4 shows an operation when installing an application program on the ICB 6. As shown in FIG. 1, the ICB 6 is connected to the TCU 12 through the in-vehicle connection link 5, the first communication line 3, and the central ECU 2. Therefore, when installing the application program on the ICB 6, the ICB 6 requests the central ECU 2 to install the application program, and the central ECU 2 downloads the application program through the TCU 12.

Here, installing the application program on the ICB 6 means a sequence of processes for storing, in the memory 65, the application program 68 in a state being executable by the program execution unit 62.

Steps S11 to S23 in FIG. 4 are executed by the program management unit 211. Moreover, step S17 is executed by the program management unit 211 and the detection unit 212.

When the ICB 6 requests the installation of an application program in response to a user's operation on the touch panel 15, the central ECU 2 receives the installation request (step S11). The central ECU 2 determines whether or not the application program requested for installation is an application program subject to the restriction operation (step S12). In step S12, the central ECU 2, for example, determines whether or not the application program requested for installation is a program specified by the restriction information 224.

If it is determined that the application program is not an application program subject to the restriction operation (NO in step S12), the central ECU 2 requests the server 110 or another server to download the application program (step 13), and executes downloading (step S14). Here, the central ECU 2 temporarily stores the downloaded application program, for example, in the RAM.

The central ECU 2 identifies electronic equipment to be controlled by the downloaded application program (step S15). The central ECU 2 extracts information about the use state of the identified electronic equipment, from the downloaded application program (step S16). In step S16, the central ECU 2 extracts information about the frequency the application program operates the electronic equipment, the number of times of operating the electronic equipment, the number of times of rewriting the semiconductor memory element, the duration of operating time, etc. The source of extracting information is, for example, the application program itself, or information that is downloadable together with the application program, and is added to the application program.

The central ECU 2 determines whether or not the information could have been extracted in step S16 (step S17). If the extraction of information is successful (YES in step S17), the central ECU 2 executes, based on the extracted information, a load determination process (step S18). Step S18 is a process for determining whether the application program puts a high load on the electronic equipment, and will be described in detail below with reference to FIG. 5.

The central ECU 2 determines, based on a result of the load determination process in step S18, whether or not the downloaded application program puts a high load on the electronic equipment (step S19). If it is determined that the downloaded application program does not put a high load (NO in step S19), the central ECU 2 executes a process for storing the downloaded application program in the ICB 6, i.e. the installation of the application program (step S20).

If it is determined that the application program puts a high load on the electronic equipment (YES in step S19), the central ECU 2 sets the downloaded application program as a subject of restriction (step S21). Accordingly, the information about the application program downloaded in step S14 is added to the restriction information 224.

The central ECU 2 executes a restriction operation with respect to the application program (step S22). For example, the central ECU 2 prohibits the installation of the application program downloaded in step S14, and deletes the downloaded application program. Further, in step S22, the central ECU 2, for example, gives a notification that the application program downloaded in step S14 puts a high load on the electronic equipment. In this case, after giving the notification, the central ECU 2 may proceed to step S20 and install the application program.

Moreover, if it is determined that the application program requested by the ICB 6 to be installed is subject to a restriction operation (YES in step S12), the central ECU 2 executes the restriction operation (step S23). If the restriction operation in step S23 is giving a notification, the central ECU 2 may proceed to step S14, after giving the notification.

FIG. 5 shows one example of the load determination process shown in step S18 of FIG. 4.

The central ECU 2 totals up the number of times of operation of the electronic equipment identified in step S15 (step S31). The number of times of operation totaled in step S31 is the accumulated number of times of operation of the electronic equipment, and, for example, is included in the history information 223. The number of times of operation may include the number of times of rewriting of the semiconductor memory element.

The central ECU 2 calculates a period since the start of using the electronic equipment (step S32), and acquires the useful life of the electronic equipment from the history information 223 (step S33). The central ECU 2 calculates the number of times of operation of the electronic equipment until the useful life of the electronic equipment, based on the number of times of operation totaled in step S31, the period since the start of using the electronic equipment, and the useful life of the electronic equipment (step S34). For example, the central ECU 2 calculates an average value of the number of times of operation per unit period, based on the number of times of operation totaled in step S31 and the period since the start of using the electronic equipment. Then, the central ECU 2 calculates, from the average value of the number of times of operation per unit period, the number of times of operation of the electronic equipment during the useful life. The number of times of operation calculated in step S34 is the anticipated number of times the electronic equipment will operate during the useful life, and is called the anticipated number of times of operation.

The central ECU 2 adds a margin to the anticipated number of times of operation, and thereby decides an acceptable range of the anticipated number of times of operation (step S35). In the example of FIG. 5, the acceptable range is a range in which the number of times obtained by adding the margin to the anticipated number of times of operation is an upper limit.

The central ECU 2 sets an execution frequency of the application program subject to determination (step S36). The execution frequency of the application program is an assumed frequency which is set based on the history of the similar application program 68 executed by the ICB 6. The central ECU 2 estimates the number of times the electronic equipment will operate due to the execution of the application program (step S37). In step S37, the central ECU 2 estimates, based on the frequency the application program operates the electronic equipment and the number of times of a single operation, the number of times the electric equipment will operate. For example, in a case in which the directional signal lamp of the vehicle V is caused to blink ten times each time the application program subject to determination operates, the number of times of operation of the directional signal lamp is 10 times for a single operation of the application program. By multiplying this by the execution frequency of the application program and the remaining duration of the useful life of the electronic equipment, the number of times of operation of the electronic equipment can be estimated.

The central ECU 2 calculates the sum of the estimated number of times of operation and the number of times of operation totaled in step S31 (step S38), and determines whether or not the calculated sum deviates from the acceptable range (step S39). In other words, the central ECU 2 determines whether or not the sum calculated in step S38 exceeds the upper limit of the acceptable range.

If it is determined that the sum deviates from the acceptable range (YES in step S39), the central ECU 2 determines that a load that the application program puts on the electronic equipment is a high load (step S40). If it is determined that the sum does not deviate from the acceptable range (NO in step S39), the central ECU 2 determines that a load that the application program puts on the electronic equipment is not a high load (step S41).

FIG. 6 shows an operation of the central ECU 2 when executing the application program. Specifically, the operation of the central ECU 2 when the program execution unit 62 executes the application program 68 installed on the ICB 6 is shown.

Steps S51 to S60 in FIG. 6 are executed by the program management unit 211. Moreover, step S55 is executed by the program management unit 211 and the detection unit 212.

When the program execution unit 62 of the ICB 6 starts executing the application program 68 in response to the user's operation on the touch panel 15, the central ECU 2 detects the execution of the application program (step S51). The central ECU 2 determines whether or not the executed application program 68 is an application program subject to the restriction operation (step S52). In step S52, the central ECU 2, for example, determines whether or not the application program 68 executed by the ICB 6 is a program specified by the restriction information 224.

If it is determined that the executed application program is not the application program 68 subject to the restriction operation (NO in step S52), the central ECU 2 identifies electronic equipment to be controlled by the application program 68 (step S53). The central ECU 2 acquires information about the use state of the electronic equipment when the application program 68 is executed (step S54). The information acquired by the central ECU 2 in step S54 includes, for example, the number of times of operation of the electronic equipment during the execution of the application program 68. In other words, in step S54, the central ECU 2 acquires, from the history information 223, the use state of the electronic equipment detected by the detection unit 212 when the application program 68 was executed in the past.

The central ECU 2 executes, based on the information acquired in step S54, a load determination process (step S55). The load determination process in step S54 is, for example, the process described with reference to FIG. 5.

The central ECU 2 determines, based on a result of the load determination process in step S55, whether or not the application program 68 puts a high load on the electronic equipment (step S56). If it is determined that the application program 68 does not put a high load (NO in step S56), the central ECU 2 proceeds to later-described step S59, without restricting the execution of the application program 68. Consequently, the ICB 6 executes the application program 68.

If it is determined that the application program 68 puts a high load on the electronic equipment (YES in step S56), the central ECU 2 sets the application program 68, which was started to be executed by the ICB 6, as a subject of restriction (step S57). Accordingly, the information about the application program 68 is added to the restriction information 224.

The central ECU 2 executes a restriction operation with respect to the application program 68 (step S57). For example, the central ECU 2 controls the ICB 6 to stop executing the application program 68. Moreover, in step S57, the central ECU 2, for example, gives a notification that the application program 68 executed by the ICB 6 puts a high load on the electronic equipment. In this case, after giving the notification, the central ECU 2 may allow the ICB 6 to execute the application program 68.

Subsequently, the central ECU 2 transmits, to the server 110, information about the use state of the electronic equipment due to the execution of the application program 68 (step S59). In step S59, the central ECU 2 transmits the information acquired in step S54 to the server 110. Further, in a case in which the application program 68 is executed by the ICB 6, the central ECU 2 may transmit, to the server 110, the use state of the electronic equipment detected by the detection unit 212 during the execution of the application program 68. In this case, the central ECU 2 transmits the information to the server 110 after finishing the execution of the application program 68, or during the execution of the application program 68.

Furthermore, if it is determined that the application program 68 executed by the ICB 6 is subject to a restriction operation (YES in step S52), the central ECU 2 executes the restriction operation (step S60). Similarly to step S58, the restriction operation includes controlling the ICB 6 to stop executing the application program 68, or give a notification that the application program 68 puts a high load on the electronic equipment. In the case in which the notification is given as a restriction operation in step S60, after giving the notification, the central ECU 2 may allow the ICB 6 to execute the application program 68. After the restriction operation in step S60, the central ECU 2 proceeds to step S59.

The information that is transmitted to the server 110 in step S59 is accumulated by the server 110. Consequently, the server 110 can acquire, for each application program, information about a mode in which the application program operates the electronic equipment of the vehicle V.

After the execution of the application program 68 is started, the central ECU 2 may execute the operation of steps S54 to S60 in FIG. 6 during the execution of the application program 68. For example, the central ECU 2 always, or at a predetermined time interval, detects the use state of the electronic equipment with the detection unit 212, and updates the history information 223. Then, the central ECU 2 acquires information in step S54 from the updated history information 223, and makes a determination in step S55. In this case, the central ECU 2 can execute the restriction operation with respect to the application program 68 being executed, based on the use state of the electronic equipment during the execution of the application program 68. For example, the central ECU 2 can perform a process, such as giving a notification to the user, restricting the execution of the application program 68, or stopping the application program 68. Consequently, when it is found that the application program 68 being executed by the ICB 6 puts a high load on the electronic equipment, it is possible to perform the restriction operation without waiting for the application program 68 to finish. This is effective for the application program 68 which is, for example, executed continuously for a long time.

The above embodiment describes one specific example to which the present invention is applied, and does not intend to limit embodiments to which the present invention is applied.

In the above embodiment, as a specific example of the restriction operation which is executed by the program management unit 211, prohibiting the installation of the application program, stopping the execution of the application program, and giving the notification are described. This is one example, and the restriction operation may be, for example, restricting the execution of the application program. Specifically, for each application program, a restriction on the number of times of execution in a predetermined period may be set, and the program management unit 21 may prohibit the application program from being executed beyond the restriction. The predetermined period can be an appropriate period, such as one day, one week, and one month. The restriction on the number of times of execution may be, for example, calculated by the program management unit 211 so that the sum of the number of times of operation of the electronic equipment obtained in the process in FIG. 5 and the estimated number of times of operation does not deviate from the acceptable range. The central ECU 2 may decide the number of times of execution, for example, when installing the application program, or when executing the application program for the first time.

Moreover, restricting the execution of the application program may be, for example, restricting the time in which the application program is executed. Specifically, for each application program, the program management unit 211 sets a time limit from the start of executing the application program, and finishes the application program upon reaching the time limit. The time limit may be, for example, calculated by the program management unit 211 so that the sum of the number of times of operation of the electronic equipment obtained in the process in FIG. 5 and the estimated number of times of operation does not deviate from the acceptable range. The program management unit 211 may decide the time limit, for example, when installing the application program, or when executing the application program for the first time. Alternatively, for the execution of the application program, the program management unit 211 may combine the restriction by the time limit and the restriction on the number of times of execution in a predetermined period.

Further, the central ECU 2 may decide the content of the restriction operation, based on the use state of the electronic equipment by the application program. For example, when the load on the electronic equipment indicated by the use state of the electronic equipment is a high load, the central ECU 2 may give a notification as a restriction operation, and, when the load on the electronic equipment is a higher load, the central ECU 2 may prohibit the execution of the application program as a restriction operation.

The above embodiment describes an example in which the program management unit 211 executes the load determination process (step S18), after downloading the application program. This is one example, and the program management unit 211 may, for example, acquire information about the application program from the server, before downloading the application program, and execute the process of steps S15 to S19. In this case, the program management unit 211 may download the application program in step S20.

Alternatively, in the above embodiment, the program management unit 211 may acquire information about the application program from a server different from a server from which the application program is downloaded, and execute the process of steps S15 to S19. Servers of this type are, for example, a server having information about assessment of the application program, a server for collecting information about the application program from the user, and a server provided by the manufacturer or selling company of the vehicle V, etc. These servers are not limited to a single server computer, and may be cloud servers.

Moreover, the above embodiment describes an example in which the subject of processing of the program management unit 211 is the application program 68 executed by the ICB 6. This is one example, and the subject of processing of the program management unit 211 may be an application program which is executed by another ECU. Further, the configuration of the control system 1 in the above embodiment is one example, and the types of ECUs provided in the control system 1, the number of the ECUs, and the configuration of electronic equipment subject to control of the ECUs can be changed in a variety of manners.

FIG. 1 and FIG. 3 are schematic views that show a functional configuration of each device in the management system 100 by classifying the configuration according to the main processing content so as to facilitate understanding of the invention of the present application, but do not intend to limit the configuration of the device. The processes shown in FIG. 4 to FIG. 6 may be executed by a single program, or may be executed by a plurality of programs.

Additionally, the vehicle V is, for example, a four-wheeled automobile, but the type of the vehicle V is not particularly limited, and may be a large vehicle, a commercial vehicle, a two-wheeled vehicle, a three-wheeled vehicle, etc. Furthermore, the configuration of each unit in the control system 1 can be arbitrarily changed.

The above embodiment supports the following configurations.

(Configuration 1) A control device including: a program management unit that manages a process of installing a program for operating electronic equipment, onto a program execution unit for executing the program, and the execution of the program by the program execution unit; and a detection unit that detects a use state of the electronic equipment, wherein the program management unit executes, based on the use state of the electronic equipment detected by the detection unit, a restriction operation at least either when the program is installed or when the program is executed, and the restriction operation includes any one of outputting a notification, restricting the installation of the program, and restricting the execution of the program.

According to the control device with configuration 1, when installing or executing a program for operating electronic equipment, it is possible to impose a restriction, depending on the use state of the electronic equipment by a new program. Consequently, it is possible to restrict the installation or execution of a program that puts an inappropriate load on the electronic equipment, or puts a high load on the electronic equipment. Therefore, it is possible to prevent or reduce unexpected troubles of the electronic equipment, and achieve a long life of the electronic equipment, or prevent shortening of the life. For example, it is possible to realize an appropriate use of electronic equipment mounted on a vehicle, and improve the safety and ride comfortability of the vehicle.

(Configuration 2) The control device according to configuration 1, wherein, when installing the program, the program management unit acquires, from the program, information identifying the electronic equipment to be operated by the program, and executes the restriction operation based on the acquired information.

According to the control device with configuration 2, it is possible to restrict the installation of a program that puts an inappropriate load on the electronic equipment, or puts a high load on the electronic equipment. Therefore, it is possible to realize protection of the electronic equipment, and achieve a long life of the electronic equipment, or prevent shortening of the life.

(Configuration 3) The control device according to configuration 1 or configuration 2, wherein the program management unit determines a load on the electronic equipment, based on the use state of the electronic equipment during the execution of the program, and executes the restriction operation when the load on the electronic equipment is a high load.

According to the control device with configuration 3, it is possible to appropriately determine, based on the use state of the electronic equipment during the execution of the program, whether or not the program puts an inappropriate load on the electronic equipment, or puts a high load on the electronic equipment.

Consequently, it is possible to more reliably realize protection of the electronic equipment.

(Configuration 4) The control device according to configuration 3, wherein, when the load on the electronic equipment during the execution of the program is a high load, the program management unit outputs the notification.

According to the control device with configuration 4, when a load applied to the electronic equipment by the program operating the electronic equipment is a high load, it is possible to warn a user by giving the notification. Consequently, the user can appropriately use the program, and both user convenience and protection of the electronic equipment can be achieved.

(Configuration 5) The control device according to configuration 3 or 4, wherein, when the load on the electronic equipment during the execution of the program is a high load, the program management unit prohibits at least either installing the program or executing the program.

According to the control device with configuration 5, when the load applied to the electronic equipment by the program operating the electronic equipment is a high load, it is possible to prohibit at least either installing the program or executing the program. Consequently, it is possible to realize protection of the electronic equipment, and achieve a long life of the electronic equipment, or prevent shortening of the life.

(Configuration 6) The control device according to any one of configuration 1 to configuration 5, wherein the electronic equipment is mounted on a vehicle, and the program is executed by the program execution unit provided in on-vehicle equipment.

According to the control device with configuration 6, it is possible to impose a restriction on the program, depending on the use state of the electronic equipment by the program executed by the equipment mounted on the vehicle. Consequently, it is possible to realize an appropriate use of the electronic equipment mounted on the vehicle, and improve the safety and ride comfortability of the vehicle.

(Configuration 7) The control device according to any one of configuration 1 to configuration 6, wherein the detection unit detects at least any one of the number of times of operation of the electronic equipment, an operating time, and an elapsed period after manufacturing, as the use state of the electronic equipment.

According to the control device with configuration 7, the load applied to the electronic equipment by the program can be assessed based on at least any one of the number of times of operation of the electronic equipment, the operating time, and the elapsed period after manufacturing of the electronic equipment. Consequently, it is possible to prevent or reduce unexpected troubles of the electronic equipment, and achieve a long life of the electronic equipment, or prevent shortening of the life.

(Configuration 8) A control method including: managing a process of installing a program for operating electronic equipment, onto a program execution unit for executing the program, and the execution of the program by the program execution unit; detecting a use state of the electronic equipment; and executing, based on the use state of the electronic equipment, a restriction operation at least either when the program is installed or when the program is executed, the restriction operation including any one of outputting a notification, restricting the installation of the program, and restricting the execution of the program.

According to the control method with configuration 8, when installing or executing a program for operating electronic equipment, it is possible to impose a restriction, depending on the use state of the electronic equipment by a new program. Consequently, it is possible to restrict the installation or execution of a program that puts an inappropriate load on the electronic equipment, or puts a high load on the electronic equipment. Therefore, it is possible to prevent or reduce unexpected troubles of the electronic equipment, and achieve a long life of the electronic equipment, or prevent shortening of the life. For example, it is possible to realize an appropriate use of electronic equipment mounted on a vehicle, and improve the safety and ride comfortability of the vehicle.

### REFERENCE SIGNS LIST

1 . . . control system, 2 . . . central ECU (control device), 3 . . . first communication line, 4 . . . second communication line, 5 . . . in-vehicle connection link, 6 . . . ICB, 29 . . . zone A-ECU, 30 . . . lamp body, 61 . . . processor, 62 . . . program execution unit, 65 . . . memory, 66 . . . control program, 68 . . . application program, 100 . . . management system, 110 . . . server, 210 processor, 211 . . . program management unit, 212 . . . detection unit, 220 . . . memory, 221 . . . control program, 222 . . . equipment information, 223 . . . history information, 224 . . . restriction information, B . . . base station, N . . . communication network, and V . . . vehicle.

What is claimed is:

1. A control device comprising:
a program management unit that manages a process of installing a program for operating electronic equipment, onto a program execution unit for executing the program, and the execution of the program by the program execution unit; and
detection unit that detects a use state of the electronic equipment, wherein
the program management unit executes, based on the use state of the electronic equipment detected by the detection unit, a restriction operation at least either when the program is installed or when the program is executed, and
the restriction operation includes any one of outputting a notification, restricting the installation of the program, and restricting the execution of the program.

2. The control device according to claim 1, wherein, when installing the program, the program management unit acquires, from the program, information identifying the electronic equipment to be operated by the program, and executes the restriction operation based on the acquired information.

3. The control device according to claim 1, wherein the program management unit determines a load on the electronic equipment, based on the use state of the electronic equipment during the execution of the program, and executes the restriction operation when the load on the electronic equipment is a high load.

4. The control device according to claim 3, wherein, when the load on the electronic equipment during the execution of the program is a high load, the program management unit outputs the notification.

5. The control device according to claim 3, wherein, when the load on the electronic equipment during the execution of the program is a high load, the program management unit prohibits at least one of installing the program and executing the program.

6. The control device according to claim 1, wherein the electronic equipment is mounted on a vehicle, and the program is executed by the program execution unit provided in on-vehicle equipment.

7. The control device according to claim 1, wherein the detection unit detects at least any one of the number of times of operation of the electronic equipment, an operating time, and an elapsed period after manufacturing, as the use state of the electronic equipment.

8. A control method comprising:
managing a process of installing a program for operating electronic equipment, onto a program execution unit for executing the program, and the execution of the program by the program execution unit;
detecting a use state of the electronic equipment; and
executing, based on the use state of the electronic equipment, a restriction operation at least either when the program is installed or when the program is executed, the restriction operation including any one of outputting a notification, restricting the installation of the program, and restricting the execution of the program.
